(19) United States
(12) Patent Application Publication
(10) Pub. No.: US 2025/0220145 A1
(43) Pub. Date: Jul. 3, 2025

(54) PARALLAX INFORMATION GENERATION DEVICE, PARALLAX INFORMATION GENERATION METHOD, AND PARALLAX INFORMATION GENERATION PROGRAM

(71) Applicant: Panasonic Intellectual Property Management Co., Ltd., Osaka (JP)

(72) Inventors: Yusuke YUASA, OSAKA FU (JP); Shigeru SAITOU, KYOTO FU (JP); Hiromu KITAJIMA, HYOGO KEN (JP)

(21) Appl. No.: 18/850,271

(22) PCT Filed: Mar. 20, 2023
(86) PCT No.: PCT/JP2023/010948

§ 371 Date: Sep. 24, 2024

(30) Foreign Application Priority Data
Mar. 25, 2022 (JP) 2022-049919

(51) Int. Cl. H04N 13/111; H04N 13/00; H04N 13/178; H04N 13/239; H04N 13/25

(52) U.S. Cl. CPC H04N 13/111; H04N 13/178; H04N 2013/0092; H04N 13/239; H04N 13/25

(57) ABSTRACT

A parallax information generation device includes: an imaging unit; a process target area determination unit configured to determine a process target area to be subjected to a predetermined image processing in a base image and a reference image captured by the imaging unit; and an image processing unit configured to perform the predetermined image processing to the process target area to generate parallax information. The process target area determination unit identifies a dynamic area in an image capturing scene, by comparing the images between frames, and determines, as the process target area, an area including a part or the entirety of the dynamic area and a part of a static area that is an area other than the dynamic area.

### TECHNICAL FIELD

The present disclosure relates to a technology for generating parallax information and distance information for a plurality of images taken from different viewpoints.

### BACKGROUND ART

Patent Document 1 discloses a technology related to a stereo measurement device. In the configuration disclosed in Patent Document 1, motion areas are extracted from images captured by left and right cameras, and distance information is obtained through stereo matching targeting only the motion areas.

Patent Document 2 discloses a technology related to an image processing device that generates a parallax map. In the configuration of Patent Document 2, a subject area (e.g., face or an object in the center of the image, a moving object, and the like) is extracted from one image, and the subject area and non-subject area are subjected to stereo-processing with different resolution, and combined to generate the parallax map.

### CITATION LIST

### Patent Document

Patent Document 1: Japanese Unexamined Patent Publication No. 2009-68935
Patent Document 2: Japanese Unexamined Patent Publication No. 2012-133408

### SUMMARY OF THE INVENTION

### Technical Problem

Although the technology in Patent Document 1 enables speeding up of processes, because a matching area is smaller than the entire screen, it is difficult to accurately update distance information in an area other than the motion area. The technology in Patent Document 2 suppresses a calculation amount for the stereo matching process, and therefore assumes the matching process is performed after reducing the size of the area outside the subject area. Such an approach causes a lower resolution of the area outside the subject, consequently leading to reduction of the resolving power of the parallax and the depth distance calculated from the parallax.

The present disclosure is made in view of the above points, and it is an object of the present disclosure to improve the processing speed without reducing the accuracy in generating parallax information.

### Solution to the Problem

A parallax information generation device related to an aspect of the present disclosure, which is configured to generate parallax information indicating a parallax amount between a plurality of images, includes: an imaging unit configured to capture a plurality of images with different viewpoints; a process target area determination unit configured to set a base image and a reference image out of the plurality of images captured by the imaging unit, and determine a process target area to be subjected to a predetermined image processing in the base image and the reference image; and an image processing unit configured to perform the predetermined image processing to the process target area of each of the base image and the reference image to generate parallax information. The process target area determination unit identifies a dynamic area in an image capturing scene, by comparing a plurality of images between frames, and determines, as the process target area, an area including a part or the entirety of the dynamic area and a part of a static area that is an area other than the dynamic area.

### Advantages of the Invention

The present disclosure allows generation of parallax information without reducing the accuracy while enabling speeding up of the processing, in a parallax information generation device.

### BRIEF DESCRIPTION OF THE DRAWINGS

FIG. 1 shows an exemplary configuration of a parallax information generation device according to an embodiment.

FIG. 2 shows an algorithm for stereo matching process.

FIG. 3 is an overview of a resemblance calculation process.

FIG. 4 is an exemplary image with a detected event area.

FIG. 5 shows an exemplary process related to a first embodiment.

FIG. 6 shows a flowchart illustrating an exemplary process according to the first embodiment.

FIG. 7 shows another exemplary process according to the first embodiment.

FIG. 8 shows an exemplary change in reliability level when an object disappears.

FIG. 9 shows an exemplary change in reliability level when an object disappears.

FIG. 10 shows a flowchart illustrating an exemplary process according to a second embodiment.

FIG. 11A and FIG. 11B are each an explanatory diagram of correspondence information between a base image and a reference image.

FIG. 12 shows an exemplary pattern of resemblance distribution.

FIG. 13 shows an exemplary hardware configuration according to the first embodiment.

FIG. 14 shows an exemplary sequence in the configuration shown in FIG. 13.

FIG. 15 shows an exemplary hardware configuration according to the second embodiment.

FIG. 16 shows an exemplary sequence in the configuration shown in FIG. 15.

### DESCRIPTION OF EMBODIMENTS

### (Overview)

A parallax information generation device related to an aspect of the present disclosure, which is configured to generate parallax information indicating a parallax amount between a plurality of images, includes: an imaging unit configured to capture a plurality of images with different viewpoints; a process target area determination unit configured to set a base image and a reference image out of the plurality of images captured by the imaging unit, and determine a process target area to be subjected to a predetermined image processing in the base image and the reference image; and an image processing unit configured to perform the predetermined image processing to the process target area of each of the base image and the reference image to generate parallax information. The process target area determination unit identifies a dynamic area in an image capturing scene, by comparing a plurality of images between frames, and determines, as the process target area, an area including a part or the entirety of the dynamic area and a part of a static area that is an area other than the dynamic area.

Thus, the process target area to be subjected to a predetermined image processing in a parallax information generation device includes a part of a static area that is an area other than the dynamic area, in addition to a part or the entirety of the dynamic area in an image capturing scene. Since the predetermined image processing is performed not only to the dynamic area but also to a part of the static area, parallax information can be generated without reducing the accuracy, while enabling speeding up of the process.

For example, the predetermined image processing is a stereo matching process.

The above configuration may be adapted so that the process target area determination unit determines the process target area so that the number of pixels in the process target area satisfies a predetermined condition.

Setting of a predetermined condition allows appropriate control of the processing amount and the processing speed of the stereo matching process.

The above configuration may be adapted so that the predetermined condition is the number of pixels in the process target area being constant between frames.

This enables a stable frame rate.

The above configuration may be adapted so that the process target area determination unit sets, in the static area, an area to be preferentially incorporated into the process target area.

This way, an area to be subjected to the stereo matching process is preferentially set in the static area.

Further, the above-configuration may be adapted so that the image processing unit includes a corresponding point search unit configured to identify at least two corresponding pixels in the reference image, which are pixels resembling to the pixels in the base image, and store the corresponding relationship of the identified pixels as correspondence information; and the process target area determination unit identifies a pixel position corresponding to a pixel position in the dynamic area by referring to the correspondence information, and incorporates the identified pixel position in the process target area.

Thus, for each pixel position in the dynamic area, the corresponding pixel position is identified by referring to the correspondence information stored in the corresponding point search unit, and the identified pixel position is incorporated into the process target area. This way, a predetermined image processing is performed for a pixel position of a pixel resembling to a pixel of the dynamic area.

Further, the above configuration may be adapted so that the corresponding point search unit derives distribution of pixel resemblance in a predetermined area of the reference image in relation to pixels in the base image, and identify pixels at positions with a peak of the distribution as the corresponding pixels.

In this way, as the correspondence information, a pixel in the base image is associated with a highly resembling pixel in the reference image.

Further, the above configuration may be adapted so that the corresponding point search unit incorporates, into the correspondence information, information related to resemblance between a pixel in the base image and a corresponding pixel in the reference image, and the process target area determination unit determines whether an object in the position of a pixel in the dynamic area of the base image has changed, based on a difference in the pixel value of the corresponding pixel in the reference image between frames, and removes the position of the pixel from the process target area, when it is determined that the object has not changed.

Thus, when it is determined that an object at the position of a pixel in the dynamic area of the base image has not changed, the predetermined image processing can be omitted for that position of the pixel.

Further, the above configuration may be adapted so that the image processing unit includes a reliability information generator configured to generate reliability information indicating reliability of a correspondence relationship between the base image and the reference image, and generates parallax information for an image area for which the reliability information indicates higher reliability than a predetermined value.

Further, the above configuration may be adapted so that the image processing unit includes a distance information generator configured to generate distance information of a target, by using the parallax information.

A parallax information generation method related to an aspect of the present disclosure, which is configured to generate parallax information indicating a parallax amount between a plurality of images, includes: a first step of setting a base image and a reference image out of the plurality of images with different viewpoints, and determine a process target area to be subjected to a predetermined image processing in the base image and the reference image; and a second step of performing the predetermined image processing to the process target area to generate parallax information. The first step includes identifying a dynamic area in an image capturing scene, by comparing frames of the plurality of images, and determining, as the process target area, an area including a part or the entirety of the dynamic area and a part of a static area that is an area other than the dynamic area.

For example, the predetermined image processing is a stereo matching process.

Further, another aspect of the present disclosure may be a program configured to cause a computer to execute the parallax information generation method of the above described aspect.

Now, embodiments will be described in detail with reference to the drawings. Note that unnecessarily detailed description may be omitted. For example, detailed description of already well-known matters or repeated description of substantially the same configurations may be omitted. This is to reduce unnecessary redundancy of the following description and to facilitate the understanding by those skilled in the art.

The accompanying drawings and the following description are provided for sufficient understanding of the present disclosure by those skilled in the art, and are not intended to limit the subject matter of the claims.

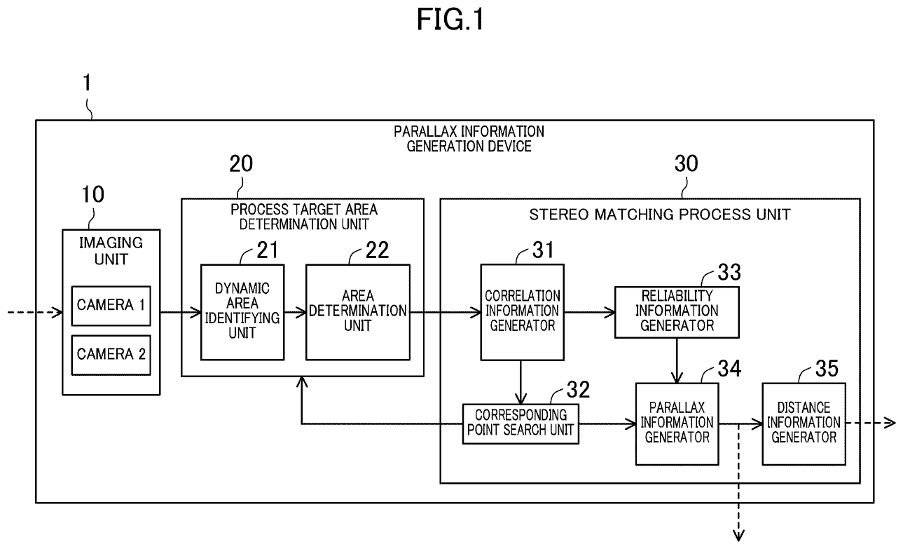

FIG. 1 is a block diagram showing an exemplary configuration of a parallax information generation device according to an embodiment. The parallax information generation device 1 of FIG. 1 is a device configured to generate parallax information that indicates a parallax amount between a plurality of images, and includes an imaging unit 10, a process target area determination unit 20, and a stereo matching process unit 30 as an exemplary image processing unit. The parallax information generation device 1 of FIG. 1 outputs the generated parallax information to the outside. Alternatively, the parallax information generation device 1 of FIG. 1 outputs distance information generated using the parallax information to the outside.

The imaging unit 10 captures a plurality of images from different viewpoints. For example, the imaging unit 10 is a stereo camera including two cameras that are at the same level and parallel to each other. The cameras include image sensors having the same number of pixels longitudinally and laterally and optical systems with the same conditions such as focal length and the like. However, the cameras may have image sensors with different number of pixels or different optical systems, and may be set at different levels or angles. The present embodiment assumes that the imaging unit 10 captures two images (base image and reference image). However, the imaging unit 10 may capture a plurality of images with different viewpoints, and the process target area determination unit 20 may set the base image and the reference image from among the plurality of images captured by the imaging unit 10.

The process target area determination unit 20 determines, for an image captured by the imaging unit 10, a process target area to be subjected to a stereo matching process and includes a dynamic area identifying unit 21 and an area determination unit 22. The process in the process target area determination unit 20 will be detailed later.

The stereo matching process unit 30 performs stereo matching process that is an example of a predetermined image processing with respect to a process target area determined by the process target area determination unit 20 in the image captured by the imaging unit 10. The stereo matching process unit 30 includes a correlation information generator 31, a corresponding point search unit 32, a reliability information generator 33, a parallax information generator 34, and a distance information generator 35.

The correlation information generator 31 generates correlation information between the base image and the reference image in the process target area. The corresponding point search unit 32 generates correspondence information that is information describing correspondence of small areas in the process target area, using the correlation information. The small area may typically be a single pixel. The reliability information generator 33 generates reliability information that indicates a reliability level of correspondence between the base image and the reference image. The parallax information generator 34 generates parallax information by using the correspondence information. The distance information generator 35 generates distance information by using the parallax information. The process in the stereo matching process unit 30 will be detailed later. Note that the reliability information generator 33 may be omitted if the reliability level is not used for generating the parallax information. Further, the distance information generator 35 may be omitted if the distance information is not generated.

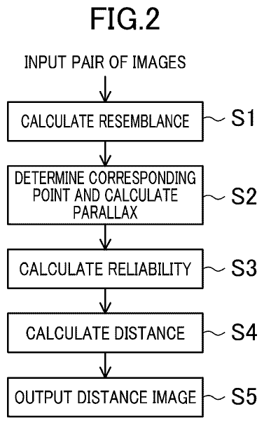

FIG. 2 shows an exemplary algorithm for the stereo matching process. In the process shown in FIG. 2, reliability levels are calculated at the same time as distance, and only a distance with a high reliability is output. Specifically, resemblance is calculated for a pair of images (base image and reference image) input (S1). By using the resemblance calculated, a corresponding point is determined for each pixel of the base image to calculate the parallax (S2). Further, based on the calculation process of S2, the reliability level is calculated for each pixel of the base image (S3). Then, for a pixel with a high reliability level, the distance is calculated by using the parallax calculated (S4). By using the distance, a distance image is generated and output (S5).

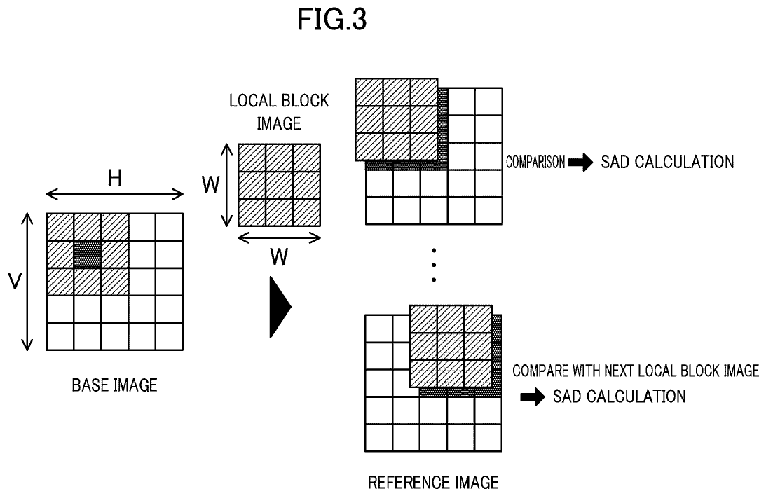

FIG. 3 is an overview of a resemblance calculation process. As shown in FIG. 3, in calculation of a resemblance for a pixel in the base image, a local block image including that pixel is determined (size w x w). Then, calculation of the resemblance for a local block of the same size in the reference image is performed while scanning the reference image in the X direction. This process is done for all the pixels in the base image.

In FIG. 3, Sum of Absolute Difference (SAD) is calculated as the resemblance. The lower the value of SAD, the higher the resemblance. Where two blocks of an image is A and B, and the luminance of each pixel of the blocks are A (x, y), B (x, y), SAD is calculated by the following equation.

$$SAD = {\sum }_{y} {\sum }_{x} \vert A ( x , y ) - B ( x , y ) \vert \qquad [ Mathematical 1 ]$$

Note that the calculation of the resemblance is not limited to SAD. For example, Normalized Cross Correlation (NCC), Zero Means Normalized Cross Correlation (ZNCC), or Sum of Squared Difference (SSD) may be used. The higher the value of NCC or ZNCC, the higher the resemblance. Further, The lower the value of SSD, the higher the resemblance.

$$NCC = \frac{{\sum }_{y} {\sum }_{x} A ( x , y ) - B ( x , y )}{\sqrt{{\sum }_{y} {\sum }_{x} {A ( x , y )}^{2} {\sum }_{y} {\sum }_{x} {B ( x , y )}^{2}}} \qquad [ Mathematical 2 ]$$

$$ZNCC = \frac{{\sum }_{y} {\sum }_{x} ( A ( x , y ) - \overline{A} ) ( B ( x , y ) - \overline{B} )}{\sqrt{{\sum }_{y} {\sum }_{x} {( A ( x , y ) - \overline{A} )}^{2} {\sum }_{y} {\sum }_{x} {( B ( x , y ) - \overline{B} )}^{2}}} \qquad [ Mathematical 3 ]$$

$$\overline{A} = \frac{1}{MN} {\sum }_{y} {\sum }_{x} A ( x , y ) , \overline{B} = \frac{1}{MN} {\sum }_{y} {\sum }_{x} B ( x , y )$$

$$SSD = {\sum }_{y} {\sum }_{z} {( A ( x , y ) - B ( x , y ) )}^{2} \qquad [ Mathematical 4 ]$$

There is an issue that stereo matching process involves a large amount of calculation. For example, in a case of resemblance calculation method shown in FIG. 3, the amount of resemblance calculation in the stereo matching process is expressed as follows.

Calculation amount ∝w²IN
w: local block size, 1: number of scanning pixels (≤H), N: total number of pixels (=V·H)
A useful approach to reduce this amount of calculation, thereby achieve speeding up of the processing, is to improve the algorithm.

In an event-driven stereo camera, the processing speed is increased by reducing N in the above equation. That is, such an event-driven stereo camera additionally performs, as a pre-processing for the stereo matching process, a process of obtaining a luminance difference from a previous frame and a process of determining that there is a moving object, an event took place. This area is referred to as a dynamic area or an event area. Note that the basis for determining whether an event took place is not limited to the difference in the luminance. For example, an event area may be identified based on other information such as the difference in the color information. Then, the stereo matching process is omitted for an area (static area, non-event area) where the difference in the luminance from the previous frame is small, determining that the distance and the reliability have not changed.

However, in a traditional approach, the stereo matching process is not performed for a non-event area and no parallax information is generated. Therefore, for example, sufficient information of the surrounding environment may not be obtained.

The present disclosure generates parallax information by including not only the event area but also a part of the non-event area in the process target area.

### First Embodiment

In the first embodiment, for example, the number of pixels of the non-event area to be incorporated into the process target area of the stereo matching process is determined so that the frame rate is stabilized.

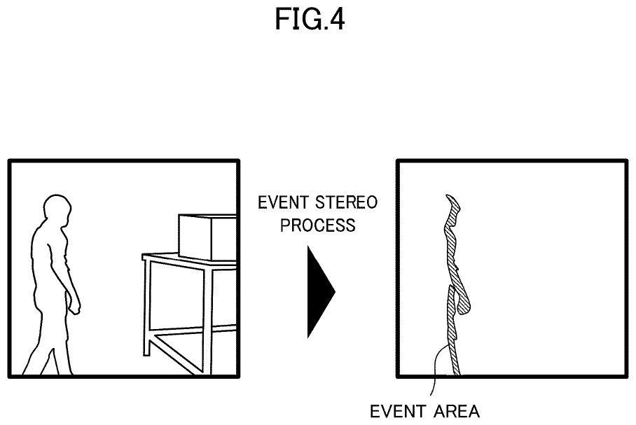

FIG. 4 shows an exemplary image obtained by capturing a person working in a factory. Since the person is working and moving, a part of the area of the person is detected as an event area, and the stereo matching process is performed. However, the traditional approach determines a background area other than the person as a non-event area, and no distance information is obtained.

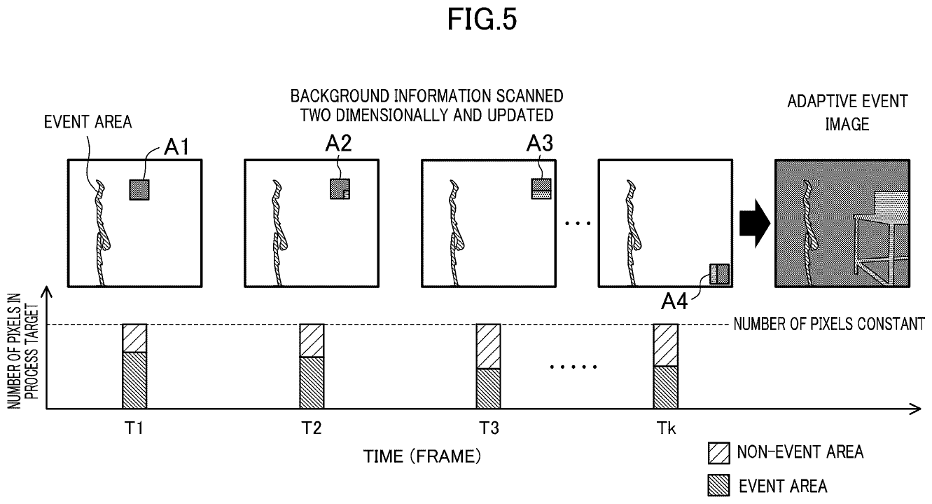

FIG. 5 is a diagram of an exemplary process related to the first embodiment. In the example of FIG. 5, the stereo matching process is performed for the event area where the person moves in each frame. Further, the stereo matching process is also performed in a part of the non-event area (rectangular areas A1 to A4). Further in the example of FIG. 5, the background information is two dimensionally scanned by moving the rectangular areas A1 to A4 in each frame. From the information obtained from the images of the plurality of frames, an adaptive event image as shown at the rightmost can be generated which includes information of the background in addition to the area of the person.

The number of pixels in the event area varies from frame to frame. Therefore, as a predetermined condition, the number of pixels in the non-event area is determined so that the number of pixels in the non-event area combined with the number of pixels in the event area is constant. This enables a stable frame rate. The number of pixels in the non-event area may be adjusted as follows. For example, the lateral size of the rectangular areas A1 to A4 shown in FIG. 5 may be increased or decreased. Alternatively, the density of pixels in the rectangular areas A1 to A4 may be adjusted without changing the size of the rectangular areas A1 to A4.

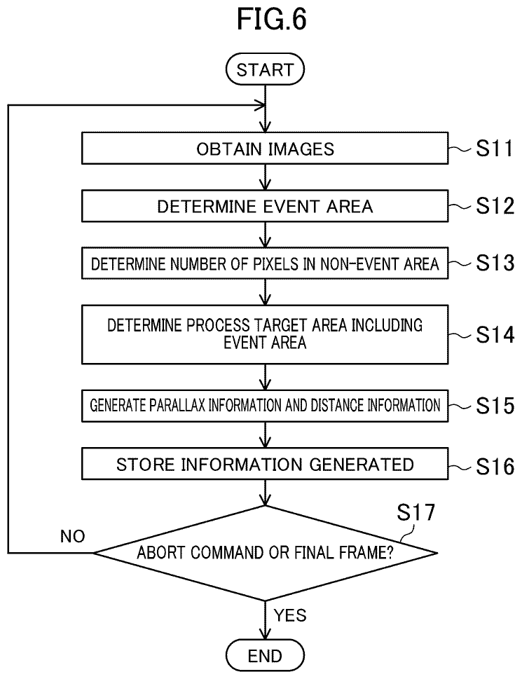

FIG. 6 shows a flowchart illustrating an exemplary process according to the present embodiment. First, the imaging unit 10 obtains a base image and a reference image (S11). Then, for each pixel of the base image, the difference in luminance from the previous frame is calculated to determine the event area (S12). Then, using the number of pixels in the event area, the number of pixels to be subjected to the stereo matching process in the non-event area is determined so as to satisfy a predetermined condition (S13). In the example of FIG. 4, the predetermined condition is that the number of pixels in the process target area is constant. Then, the process target area including the event area is determined (S14) and the parallax information and the distance information are generated through the stereo matching process (S15). The generated information is stored (S16). The above steps are repeated until an abort instruction is received or until the final frame is reached (S17).

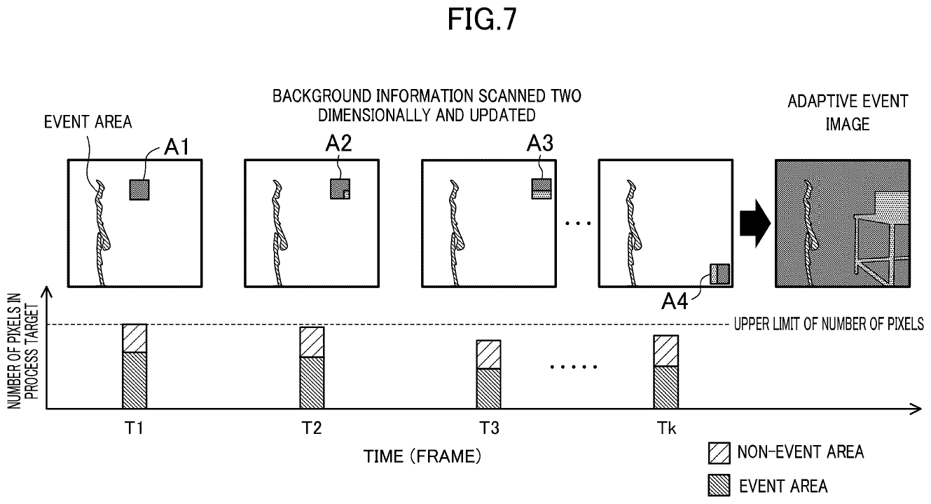

FIG. 7 is a diagram of another exemplary process related to the first embodiment. The example of FIG. 7 deals with a case where, as a predetermined condition, the number of pixels in the non-event area is determined so that the number of pixels in the non-event area combined with the number of pixels in the event area does not exceed a predetermined upper limit. That is, the number of pixels in the non-event area is not increased, even if the number of pixels including the number of pixels in the event area is smaller than the predetermined upper limit. This way, the frame rate can be stabilized to some extent, and when the event area is small, the frame rate can be increased and allocate the computing resources for the subsequent process.

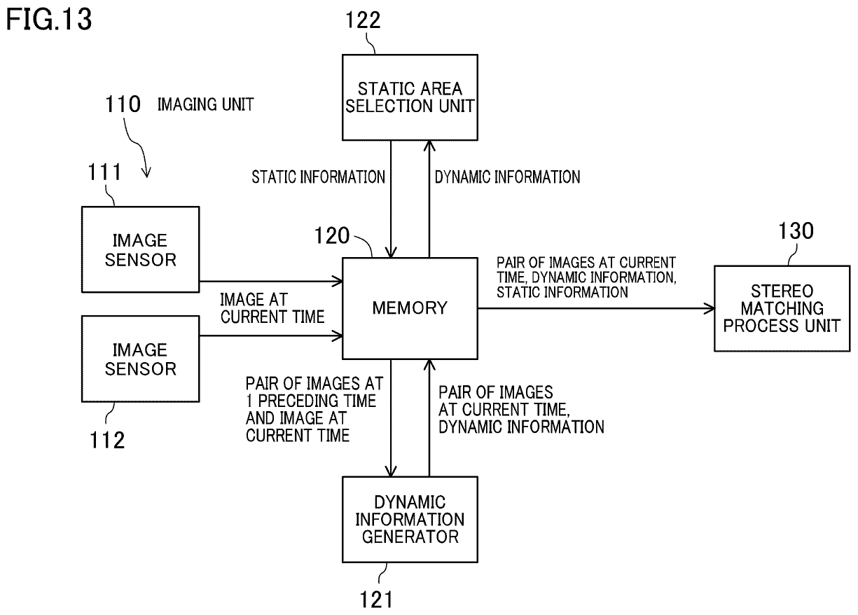

The present embodiment may be achieved by a configuration as shown in FIG. 13. The configuration of FIG. 13 includes an imaging unit 110 having image sensors 111 and 112, a memory 120, a dynamic information generator 121, a static area selection unit 122, and a stereo matching process unit 13. The dynamic information generator 121, the static area selection unit 122, and the stereo matching process unit 13 are each an arithmetic device such as an Application Specific Integrated Circuit (ASIC) or a Field Programmable Gate Array (FPGA).

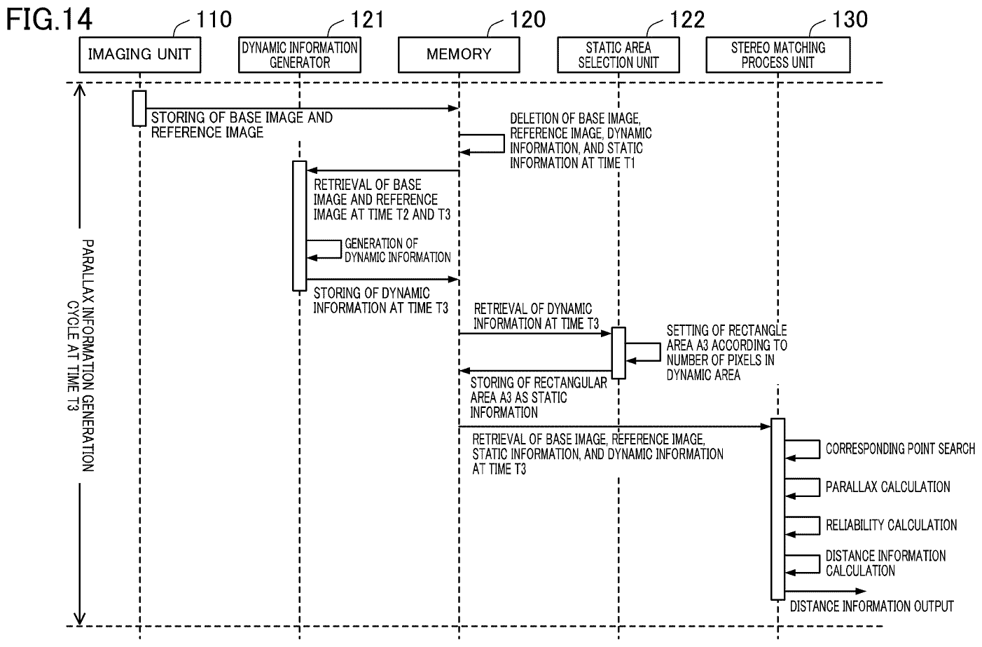

FIG. 14 shows an exemplary sequence for implementing the present embodiment in the configuration of FIG. 13. The format of the signal transmitted and received by each arithmetic device is not limited. For example, the dynamic information may be a list of coordinates of the dynamic area, or may be data obtained by encoding (chain coding or the like) a plurality of pixel areas in which the dynamic areas are adjacent to each other. Further, it is possible to output image information containing for each pixel information indicating whether the information is dynamic information.

Note that FIG. 13 is not intended to limit the hardware configuration of the present embodiment. For example, the process target area determination unit 20 and the stereo matching process unit 30 of FIG. 1 may be configured as a single processing block and integrated into a single arithmetic device such as ASIC, FPGA. Alternatively, the process target area determination unit 20 and the stereo matching process unit 30 may be configured as software that executes the steps of these units, and a processor may execute this software.

As described, in the present embodiment, the process target area to be subjected to the stereo matching process in the parallax information generation device 1 includes a part of a static area that is an area other than the dynamic area, in addition to a part or the entirety of the dynamic area in an image capturing scene. Since the stereo matching process is performed not only to the dynamic area but also to a part of the static area, parallax information can be generated without reducing the accuracy, while enabling speeding up of the process. Setting of a predetermined condition in relation to the number of pixels in the process target area allows appropriate control of the processing amount and the processing speed of the stereo matching process.

Note that the above description deals with a case where two dimensional scanning of the background information is performed for the non-event area. However, the present disclosure is not limited to this. For example, the background information may be obtained preferentially from a region closer to the event area. For example, assume a use case where a presence of an obstacle near a worker is reported. In such a case, it is advantageous to have the process target area include an area that is set in the non-event area. Further, it is not necessary to scan the entire image, and the background information may be obtained for some areas. In this case, the device may allow the user to designate an area where the user believes background information needs to be obtained.

### Second Embodiment

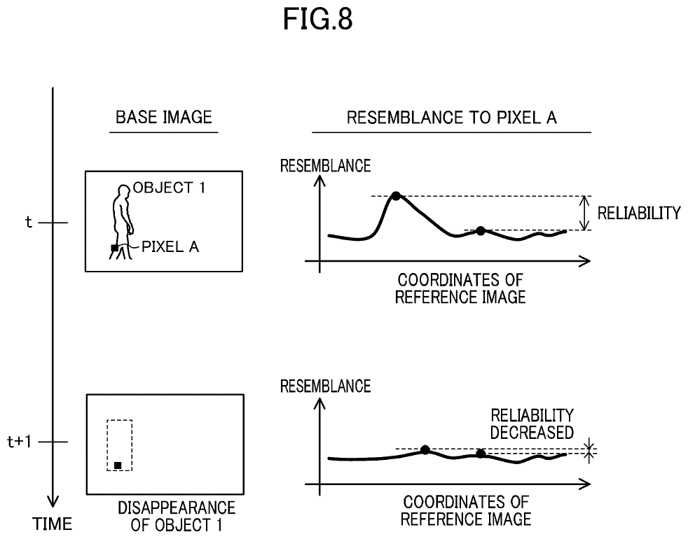

FIG. 8 shows an exemplary change in the reliability when an object disappears. FIG. 8 shows a case where an object 1 (person) is present at time t, and the object 1 disappears at time t+1. The graphs on the right show the resemblance at times t and t+1 of a pixel on an epipolar line in the reference image for a pixel a in an area of the base image, in which the object 1 is/was present. For example, the reliability is a difference between a maximum peak value and a secondary peak value in distribution of the resemblance. The larger the difference, the higher the reliability of the information of the corresponding pixel in the reference image.

The stereo matching process may use an algorithm that does not output parallax information for a pixel with a low reliability. A low reliability indicates that the selected corresponding pixel in the reference image is likely incorrect. When the reliability of an image changes, a reliable distance can be regenerated by recalculating the parallax information. This makes the estimation of the position, size, and shape of the target robust, and the accuracy of recognition and action estimation is expected to be improved.

In the example of FIG. 8, the parallax, the distance, and the reliability for the pixel a are expected to change at the time t+1. However, the pixel a is in the area with a motion of the object 1 disappearing. Therefore, in the event-driven stereo camera, the pixel a is included in the event area, and as such, is subjected to the stereo matching process.

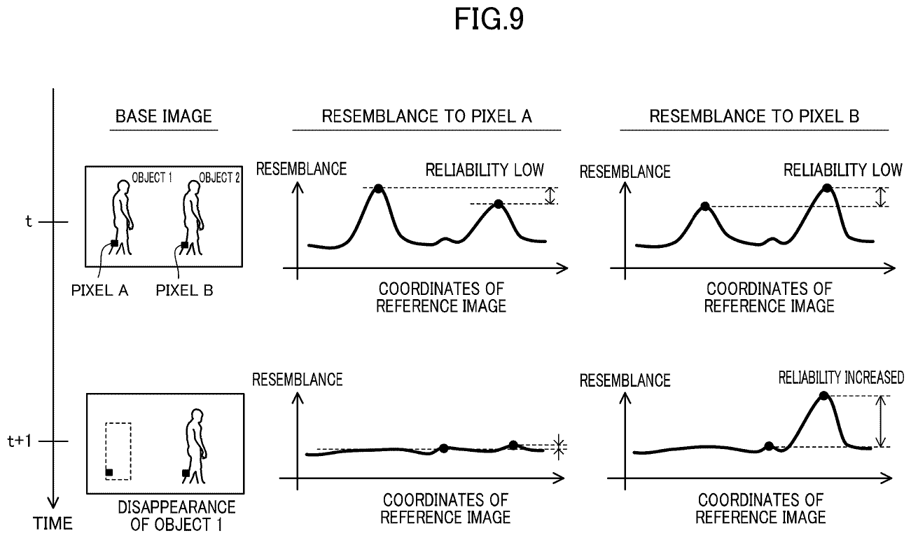

FIG. 9 shows another exemplary change in the reliability when an object disappears. FIG. 9 shows a case where objects 1 and 2 (each of them is a person) are present at time t, and the object 1 disappears at time t+1. The graphs on the right show the resemblance at times t and t+1 of pixels on an epipolar line in the reference image for a pixel a in an area of the base image, in which the object 1 is/was present, and for a pixel b in an area of the base image, in which the object 2 is present.

In the example of FIG. 9, the parallax, the distance, and the reliability for the pixel a are expected to change at the time t+1. Therefore, the pixel a is included in the event area, and as such, is subjected to the stereo matching process. In the example of FIG. 9, the reliability for the pixel b is also expected to change at the time t+1. Therefore, it is preferable to recalculate the parallax information for the position of the pixel b in order to regenerate reliable distance. However, since there is no movement taking place at the pixel B in the image, the event-driven stereo camera does not include the pixel b in the event area, and the pixel b is not subjected to the stereo matching process.

The second embodiment addresses the above-described problem.

### Example 1

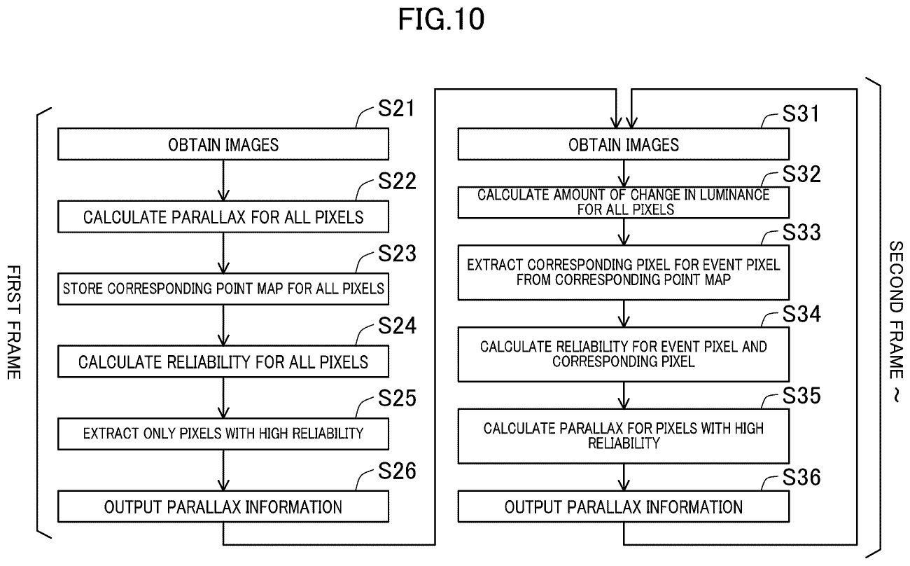

FIG. 10 shows a flowchart illustrating an exemplary process according to the present embodiment. First, steps S21 to S26 are performed for a first frame (T1). The imaging unit 10 obtains a base image and a reference image (S21). Then, the stereo matching process unit 30 calculates parallax for all the pixels and generates parallax information (S22). The corresponding point search unit 32 generates and stores a corresponding point map as correspondence information for all the pixels (S23). The corresponding point map identifies, for each pixel in the base image, at least two corresponding pixels in the reference image, which resemble to the pixel in the base image, and indicates the corresponding relationship between the identified pixels.

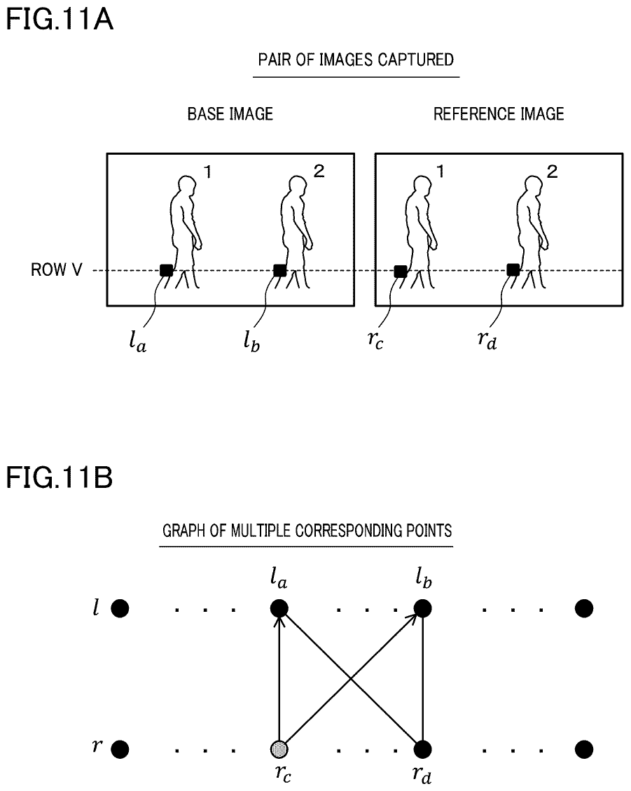

FIG. 11A shows an exemplary base image and an exemplary reference image. It is assumed that, for each pixel in the base image, two pixels in the reference image highly resembling to the pixel are stored as corresponding pixels. As shown in the graph in FIG. 11B, for a pixel 1a in the base image, pixels rc and rd in the reference image are stored as the corresponding pixels. Further, for a pixel 1b in the base image, the pixels rc and rd in the reference image are stored as the corresponding pixels.

The relationship between the pixels 1a and 1b of the base image and the pixels rc and rd of the reference image is as follows.

$$\begin{matrix}{r}_{c} = arg {max}_{r ∈ R} {S}_{{l}_{a}} ( r ) \\ {r}_{d} = arg {max}_{r ∈ {R}^{′}} {S}_{{l}_{a}} ( r ) \\ {r}_{d} = arg {max}_{r ∈ R} {S}_{{l}_{b}} ( r ) \\ {r}_{c} = arg {max}_{r ∈ {R}^{″}} {S}_{{l}_{b}} ( r )\end{matrix} \qquad [ Mathematical 5 ]$$

R: a set of horizontal pixel coordinates of the reference image
S1a: resemblance between the pixel 1a of the base image and each element of the set R
S1b: resemblance between the pixel 1b of the base image and each element of the set R
R′: a set R excluding rc
R″: a set R excluding rd

Returning to the flowchart of FIG. 10, the reliability information generator 33 calculates the reliability for all the pixels (S24). The parallax information generator 34 extracts only pixels with high reliability and outputs the parallax information of the pixels extracted (S25, S26).

Steps S31 to S36 are performed for a second frame and frames thereafter (T2-). The imaging unit 10 obtains a base image and a reference image (S31). The process target area determination unit 20 calculates an amount of change in the luminance for all the pixels and identifies an event area (dynamic area) with a motion in the image (S32). Then, for pixels (event pixels) in the event area, corresponding pixels are extracted by referring to the corresponding point map stored in the corresponding point search unit 32 (S33). The area including the event pixels and the position of the corresponding pixels extracted is the process target area. The stereo matching process unit 30 calculates the reliability for the event pixels and the corresponding pixels (S34), calculates parallax for a pixel with high reliability (S35), and outputs the parallax information (S36).

For example, it is assumed that the pixel rc of the reference image is detected as an event pixel, as in the example of FIGS. 11A and 11B. The pixel re is a first corresponding point of the pixel 1a of the base image and a second corresponding point of the pixel 1b of the base image. Therefore, the positions of the pixels 1a and 1b are included in the process target area, and the reliability and the parallax information are recalculated and updated.

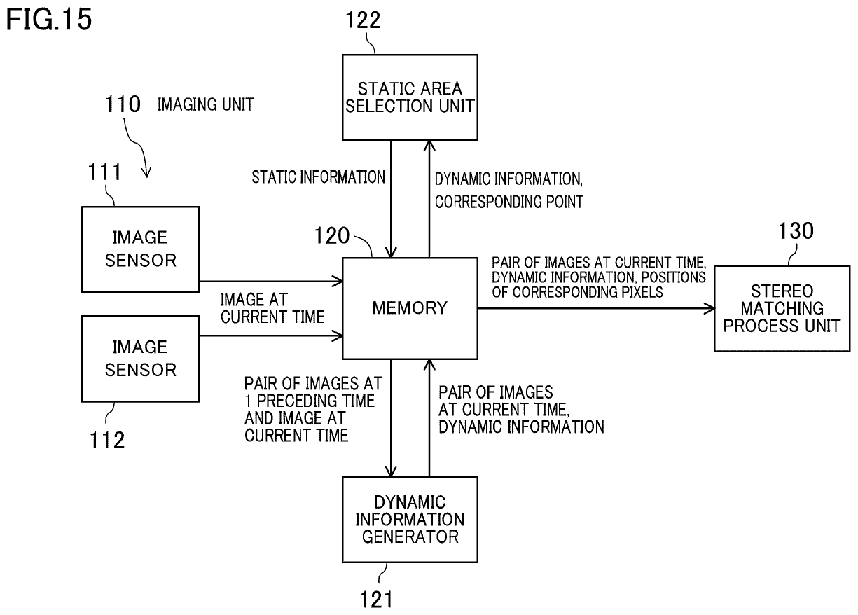

The present embodiment may be achieved by a configuration as shown in FIG. 15. The configuration of FIG. 15 includes an imaging unit 110 having image sensors 111 and 112, a memory 120, a dynamic information generator 121, a static area selection unit 122, and a stereo matching process unit 13. The dynamic information generator 121, the static area selection unit 122, and the stereo matching process unit 13 are each an arithmetic device such as ASIC or FPGA.

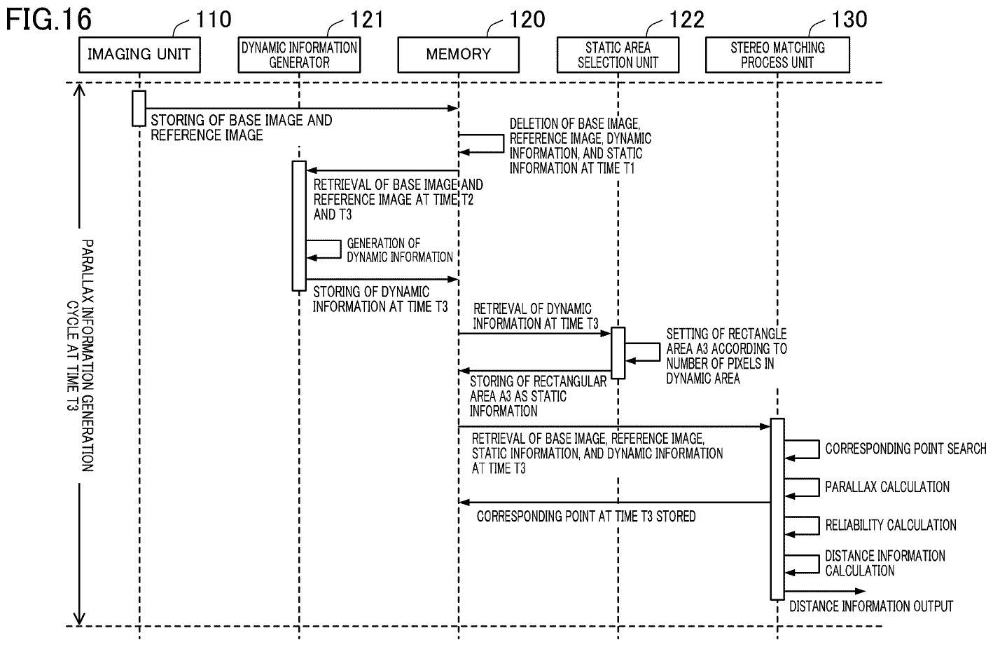

FIG. 16 shows an exemplary sequence for implementing the present embodiment in the configuration of FIG. 15. The format of the signal transmitted and received by each arithmetic device is not limited. For example, the dynamic information may be a list of coordinates of the dynamic area, or may be data obtained by encoding (chain coding or the like) a plurality of pixel areas in which the dynamic areas are adjacent to each other. Further, it is possible to output image information containing for each pixel information indicating whether the information is dynamic information.

Note that FIG. 15 is not intended to limit the hardware configuration of the present embodiment. For example, the process target area determination unit 20 and the stereo matching process unit 30 of FIG. 1 may be configured as a single processing block and integrated into a single arithmetic device such as ASIC, FPGA. Alternatively, the process target area determination unit 20 and the stereo matching process unit 30 may be configured as software that executes the steps of these units, and a processor may execute this software.

### Example 2

The foregoing Example 1 assumed that, when a pixel rc of the reference image is detected as an event pixel, the reliability and the parallax information are recalculated for the corresponding pixels 1a and 1b. In Example 2, when an event pixel is detected, whether an object in the positions of the corresponding pixels has changed is determined based on a difference in pixel values of the corresponding pixels in the reference image between frames. When the pixel values are determined to have changed, the reliability and the parallax information are recalculated. When the pixel values are determined not to have changed, the positions of the pixels are excluded from the process target area.

Specifically, for example, when an event takes place in the pixel rc of the reference image, p(1a) and p(1b) are calculated as follows for the pixels 1a and 1b of the base image.

$$\begin{matrix}p ( {l}_{a} ) = a {\dot{r}}_{c} + b {\dot{r}}_{d} \\ p ( {l}_{b} ) = c {\dot{r}}_{c} + d {\dot{r}}_{d} \\ {\dot{r}}_{c} {\dot{r}}_{{d}_{}} \\ Difference in pixel values between frames\end{matrix} \qquad [ Mathematical 6 ]$$

The symbols a, b, c, and d are predetermined coefficients. Then, when p(1a) exceeds a predetermined threshold, the reliability and the parallax are recalculated for the pixel 1a. Further, when p(1b) exceeds a predetermined threshold, the reliability and the parallax are recalculated for the pixel 1b.

For example, the coefficients a, b, c, and d are obtained by the following equation. Alternatively, the coefficients a, b, c, and d may be set and input from the outside.

$$\begin{matrix}a = \frac{{S}_{l a} ( {r}_{c} )}{{\sum }_{r ′ ∈ r} {S}_{l a} ( r ′ )} \\ b = \frac{{S}_{l a} ( {r}_{c} )}{{\sum }_{r ′ ∈ r} {S}_{l a} ( r ′ )} \\ c = \frac{{S}_{l b} ( {r}_{c} )}{{\sum }_{r ′ ∈ r} {S}_{l b} ( r ′ )} \\ d = \frac{{S}_{l b} ( {r}_{c} )}{{\sum }_{r ′ ∈ r} {S}_{l b} ( r ′ )}\end{matrix} \qquad [ Mathematical 7 ]$$

[symbol]

(r′) Resemblance of small area with the center at a pixel r′ of row r in the reference image, to a small region with the center at a pixel 1 of the base image

In the present embodiment, for each pixel position in the dynamic area, the corresponding pixel position is identified by referring to the correspondence information stored in the corresponding point search unit 32, and the identified pixel position is included in the process target area. This way, the stereo matching process is performed for the pixel positions of pixels resembling to the pixels in the dynamic area.

While the example of FIGS. 11A and 11B deals with a case where two highly resembling pixels in the reference image are stored as the corresponding pixels for each pixel in the base image, it is possible to store three or more pixels as the corresponding pixels.

In the above description, the reliability is represented by the difference between the value of the maximum peak and the value of the secondary peak in the distribution of the resemblance. The calculation of the reliability, however, is not limited to this. For example, the reliability C of the correspondence relationship between the pixel 1a and the pixel rc may be calculated as follows.

$$C = \frac{{S}_{l a} ( {r}_{c} )}{{S}_{l a} ( {r}_{d} )} \qquad [ Mathematical 8 ]$$

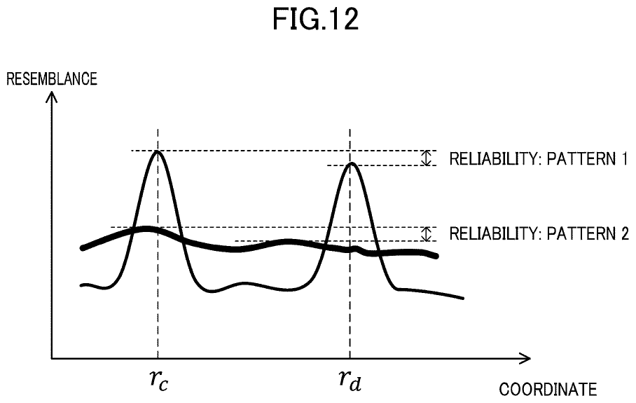

Further, for example, suppose that resemblance patterns as shown in FIG. 12 is obtained. A pattern 1 has peaks at the coordinates rc and rd, but a pattern 2 has no peak and is substantially flat. The reliability of the patterns 1 and 2 are substantially the same in this case, according to the above-described calculation of the reliability. In view of this, the reliability C may be calculated as follows.

$$C = \frac{{S}_{l a} ( {r}_{c} )}{{\sum }_{{r}^{′} ∈ r} {S}_{l a} ( {r}^{′} )} \qquad [ Mathematical 9 ]$$

Thus, the reliability increases as S1a (rc) has a relatively high value. The example of FIG. 12 results in a higher reliability for the pattern 1.

Note that, in the above-described parallax information generation device 1, the steps performed by the process target area determination unit 20 and the stereo matching process unit 30 may be executed as a parallax information generation method. Further, such a parallax information generation method may be executed by a computer by using a program.

### INDUSTRIAL APPLICABILITY

The parallax information generation device of the present disclosure allows generation of parallax information without reducing the accuracy while enabling speeding up of the processing. Therefore, for example, the parallax information generation device is useful in a safety management system for workers in a factory.

### DESCRIPTION OF REFERENCE CHARACTERS

1 Parallax Information Generation Device
10 Imaging Unit
20 Process Target Area Determination Unit
30 Stereo Matching Process Unit (Image Processing Unit)
32 Corresponding Point Search Unit
33 Reliability Information Generator
34 Parallax Information Generator
35 Distance Information Generator

1. A parallax information generation device, comprising:
an imaging unit configured to capture a plurality of images with different viewpoints;
a process target area determination unit configured to set a base image and a reference image out of the plurality of images captured by the imaging unit, and determine a process target area to be subjected to a predetermined image processing in the base image and the reference image; and
an image processing unit configured to perform the predetermined image processing to the process target area of each of the base image and the reference image to generate parallax information,
wherein the process target area determination unit
identifies a dynamic area in an image capturing scene, by comparing the plurality of images between frames, and
determines, as the process target area, an area including a part or the entirety of the dynamic area and a part of a static area that is an area other than the dynamic area.

2. The parallax information generation device of claim 1, wherein
the predetermined image processing is a stereo matching process.

3. The parallax information generation device of claim 1, wherein
the process target area determination unit
determines the process target area so that the number of pixels in the process target area satisfies a predetermined condition.

4. The parallax information generation device of claim 3, wherein
the predetermined condition is the number of pixels in the process target area being constant between frames.

5. The parallax information generation device of claim 1, wherein
the process target area determination unit sets, in the static area, an area to be preferentially incorporated into the process target area.

6. The parallax information generation device of claim 1, wherein
the image processing unit comprises
a corresponding point search unit configured to identify at least two corresponding pixels in the reference image, which are pixels resembling to the pixels in the base image, and store the corresponding relationship of the identified pixels as correspondence information; and
the process target area determination unit
identifies a pixel position corresponding to a pixel position in the dynamic area by referring to the correspondence information, and incorporates the identified pixel position in the process target area.

7. The parallax information generation device of claim 6, wherein
the corresponding point search unit
derives distribution of pixel resemblance in a predetermined area of the reference image in relation to pixels in the base image, and identify pixels at positions with a peak of the distribution as the corresponding pixels.

8. The parallax information generation device of claim 6, wherein
the corresponding point search unit
incorporates, into the correspondence information, information related to resemblance between a pixel in the base image and a corresponding pixel in the reference image; and
the process target area determination unit
determines whether an object in the position of a pixel in the dynamic area of the base image has changed, based on a difference in the pixel value of the corresponding pixel in the reference image between frames, and removes the position of the pixel from the process target area, when it is determined that the object has not changed.

9. The parallax information generation device of claim 1, wherein
the image processing unit comprises:
a reliability information generator configured to generate reliability information indicating reliability of a correspondence relationship between the base image and the reference image; and
generates parallax information for an image area for which the reliability information indicates higher reliability than a predetermined value.

10. The parallax information generation device of claim 1, wherein
the image processing unit comprises:
a distance information generator configured to generate distance information of a target, by using the parallax information.

11. A parallax information generation method, comprising:
a first step of setting a base image and a reference image out of a plurality of images with different viewpoints, and determine a process target area to be subjected to a predetermined image processing in the base image and the reference image; and
a second step of performing the predetermined image processing to the process target area to generate parallax information,
wherein the first step comprises:
identifying a dynamic area in an image capturing scene, by comparing frames of the plurality of images; and
determining, as the process target area, an area including a part or the entirety of the dynamic area and a part of a static area that is an area other than the dynamic area.

12. The parallax information generation method of claim 11, wherein
the predetermined image processing is a stereo matching process.

13. A non-transitory storage medium storing a program configured to cause a computer to execute the parallax information generation method of claim 11.
